(19) United States
(12) Patent Application Publication
(10) Pub. No.: US 2009/0194305 A1
(43) Pub. Date: Aug. 6, 2009

(54) POWER TOOL

(75) Inventors: Bingbing Xu, Nanjing (CN); Masatoshi Fukinuki, Nanjing (CN)

Correspondence Address: GREENBERG TRAURIG, LLP, 77 WEST WACKER DRIVE, SUITE 3100, CHICAGO, IL, 60601-1732, US

(73) Assignee: CHERVON LIMITED, Wanchai (HK)

(21) Appl. No.: 12/357,990

(22) Filed: Jan. 22, 2009

(30) Foreign Application Priority Data
Feb. 3, 2008 (CN) 200820031754.3

(51) Int. Cl. B25B 21/00

(52) U.S. Cl. 173/48

(57) ABSTRACT

A power tool has a motor, a clutch device for adjusting torque, a percussion device which has two cam discs, and two adjusting rings for selectively setting four operating modes including a “screwdriving” operating mode, an “impacting” operating mode, a “drilling” operating mode and a “percussion drilling” operating mode. One of the two adjusting rings is a torque adjusting ring operable to select one of the “screwdriving” operating mode, the “impacting” operating mode, and the “drilling” operating mode while the other one of the two adjusting rings is a percussion ring operable to selectively set “percussion drilling” operating mode.

### CROSS-REFERENCE TO RELATED APPLICATION

This application claims priority under 35 U.S.C. § 119 to Chinese Application No. 200820031754.3, filed Feb. 3, 2008, which is hereby incorporated by reference.

### BACKGROUND

The subject disclosure generally relates to power tools and, more particularly, relates to a power usable with a selection of operating modes.

In a known power percussion drill with a device for changing operating modes, the adjusting or changing device has two adjusting rings or changing rings, which are located side by side on the power tool housing and are embodied such that one changing ring, in three successive setting positions, calls up the “percussion drilling” operating mode, the “drilling” operating mode, and the “screwdriving” operating mode. An example of such a device may be seen in U.S. Pat. No. 7,225,884 of Bosch.

Another exemplary power tool has one changing button for setting four operating modes which is described in, for example, U.S. Pat. No. 7,308,948 of Makita. The structure utilized in this tool, however, is relatively complicated in structure and, as such, the requirements of assembly are higher which, in turn, negatively influences reliability of the tool.

### SUMMARY

The following describes a power tool with two adjusting rings for setting four operating modes including a “screwdriving” operating mode, an “impacting” operating mode, a “drilling” operating mode and a “percussion drilling” operating mode. The subject power tool can effectively prevent erroneous adjusting operation and can achieve excellent reliability.

More particularly, the described power tool comprises a motor, a clutch device for adjusting torque, a percussion device having two cam discs, two adjusting rings for selectively setting four operating modes including a “screwdriving” operating mode, an “impacting” operating mode, a “drilling” operating mode and a “percussion drilling” operating mode, wherein one of the two adjusting rings is a torque adjusting ring and operable to select one of the “screwdriving” operating mode, the “impacting” operating mode and the “drilling” operating mode, while the other one of the two adjusting rings is a percussion ring and operable to selectively set the “percussion drilling” operating mode.

### BRIEF DESCRIPTION OF THE DRAWINGS

FIG. 1 is a sectional view of an exemplary power tool;

FIG. 2 is an exploded view of the exemplary power tool of FIG. 1;

FIG. 3 is an assembly view of the exemplary power tool in the “screwdriving” operating mode;

FIG. 4 is an assembly view of the exemplary power tool in the “impacting” operating mode;

FIG. 5 is a sectional view taken along line A-A of FIG. 1 with the exemplary power tool in the “no impacting” operating mode;

FIG. 6 is a sectional view taken along line A-A of FIG. 1 with the exemplary power tool in the “impacting” operating mode;

FIG. 7 is an assembly view of the exemplary power tool in the “drilling” operating mode;

FIG. 8 is an assembly view of the exemplary power tool in the “percussion drilling” operating mode;

FIG. 9 is a sectional view of an exemplary locking device of the exemplary power tool in the “no percussion drilling” operating mode; and

FIG. 10 is a sectional view of the locking device of the power tool in the “percussion drilling” operating mode.

### DETAILED DESCRIPTION

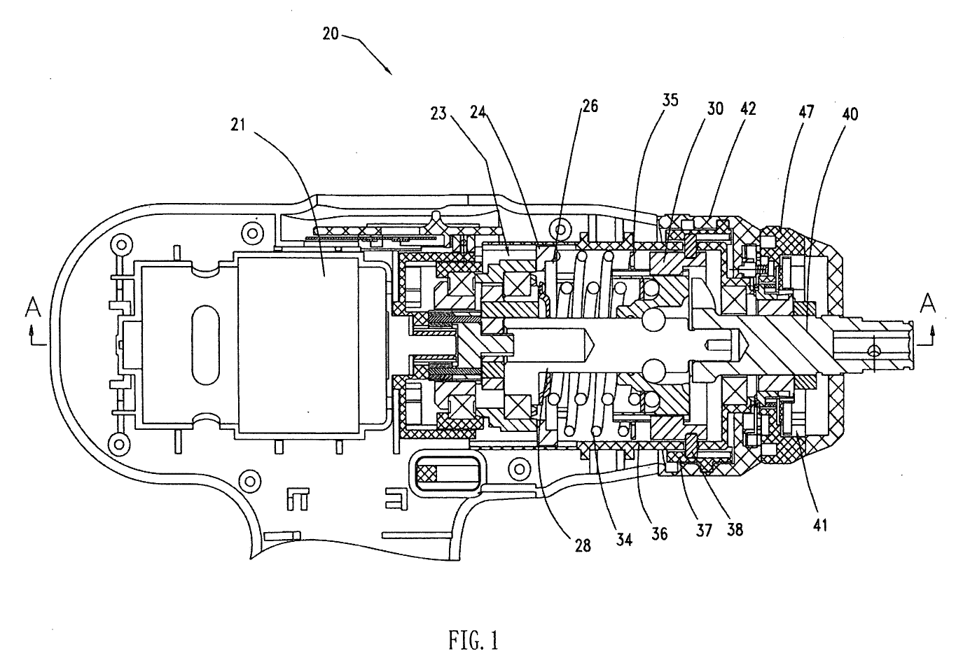

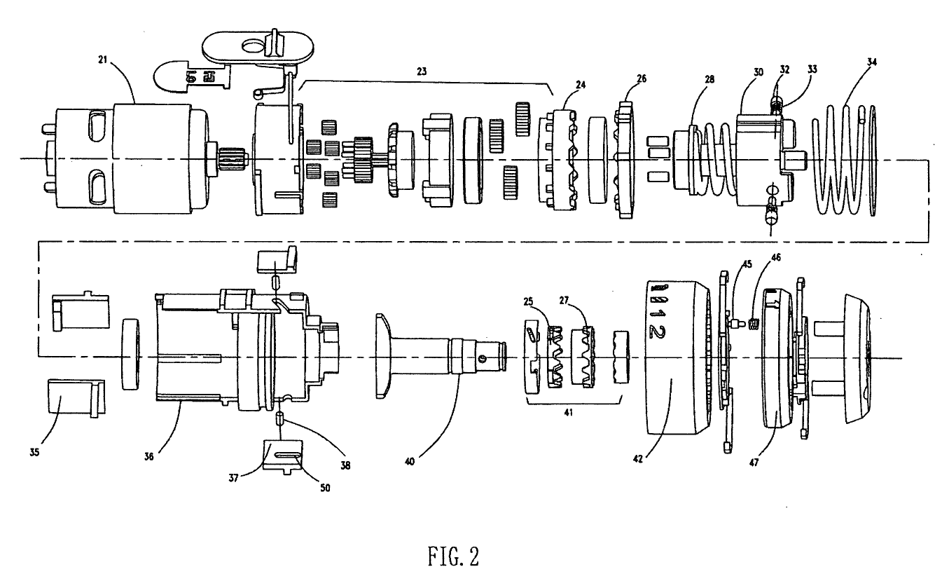

As can be seen from FIG. 1 and FIG. 2, a power tool 20 has two function rings (a torque ring 42 and a percussion ring 47) for setting four operating modes including a “screwdriving” operating mode, an “impacting” operating mode, a “drilling” operating mode and a “percussion drilling” operating mode. The power tool 20 has three working parts. A first working part comprises a clutch assembly including a motor 21, a speed adjusting device 23, a locking ring 26, a torque spring 34 and a torque blocking device 35. A second working part comprises an impacting device including a hammer 30 and an anvil 40. A third working part comprises a percussion device 41 including two cam discs 25 and 27.

According to this exemplary embodiment, three mode symbols including the “screwdriving” operating mode, the “impacting” operating mode and the “drilling” operating mode may be marked on the torque ring 42 while the “percussion drilling” operating mode and a “no percussion” operating mode may be marked on the percussion ring 47. That is to say, power tool 20 allows for four operating modes to be set with the torque ring 42 and the percussion ring 47.

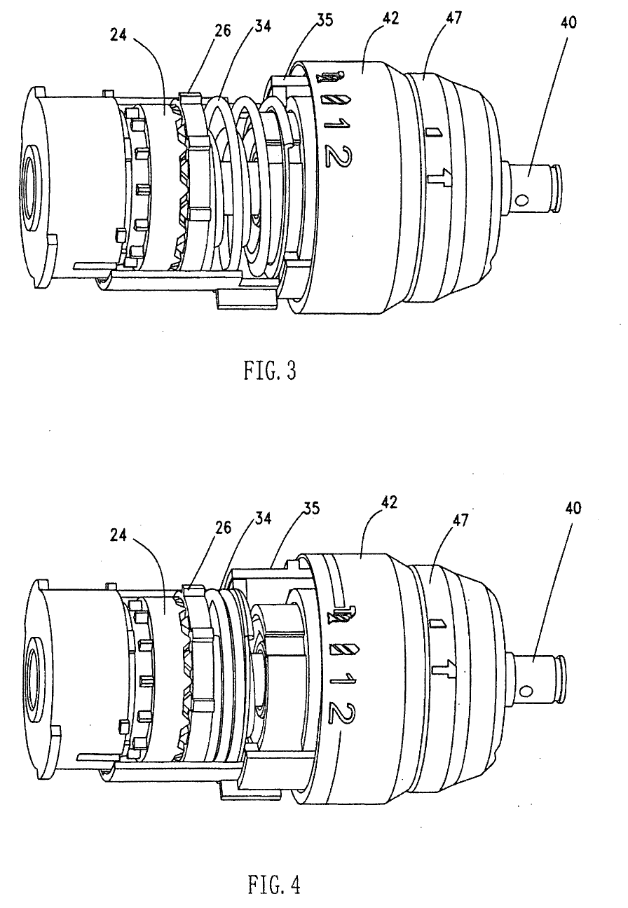

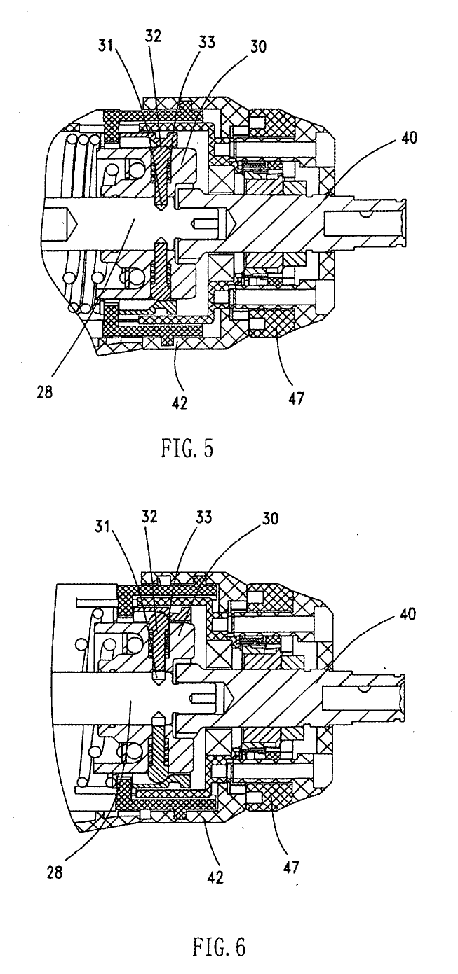

FIG. 3 is an assembly view of the power tool 20 in the “screwdriving” operating mode with the percussion ring 47 being in the “no percussion” operating mode. Number symbols on the torque ring 42 are set for the corresponding torque and the locking ring 26 is kept in engagement with gear wheel 24. When the torque ring 42 is turned to a larger number symbol position, the power tool 20 is operable to output a stronger torque. FIG. 5 shows a section view taken along line A-A of the power tool 20 in the “no impacting” operating mode and, as illustrated, a locking pin 32 engages with a groove 31 of the shaft 28 so that the hammer 30 is locked rotatably with the shaft 28, i.e., the hammer 30 is locked rotatably with the anvil 40 and the power tool 20 is in the no impacting operating mode. According to the FIG. 5 and FIG. 1, it can be seen that, by rotating the torque ring 42 to its “impacting” operating position along a direction in which the number symbols become larger, the torque ring 42 will drive an adjusting block 37 set on a gear box 36 by a adjusting pin 38 to release the engagement of the locking pin 32 and the groove 31, and then the power tool 20 will be in the “impacting” operating mode.

FIG. 4 is an assembly view of the power tool 20 in the “impacting” operating mode and, as illustrated, the locking ring 26 is kept in engagement with gear wheel 24 and the power tool 20 is kept in a mode for outputting a maximum torque. As can be seen from FIG. 6 and FIG. 2, the adjusting block 37 releases the locking pin 32 by the torque ring 42 and a spring 33 set on the locking pin 32 drives the locking pin 32 to disengage with the groove 31 of the shaft 28 so that the hammer 30 is rotatable relative to the anvil 40 and the power tool 20 is in the “impacting” operating mode. As the torque ring 42 continues to be rotated, the rotation of the torque ring 42 will move an end of the locking pin 32 to disengage the groove 50 of the adjusting block 37 and the locking pin 32 is driven to compress the spring 33 so that the other end of the locking pin 32 will engage with the groove 31 and the power tool 20 will be in the “drilling” operating mode with no impacting.

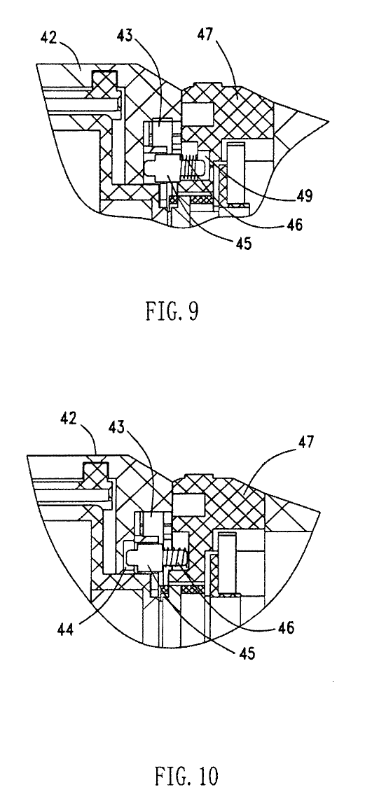

FIG. 7 is an assembly view of the power tool 20 in the “drilling” operating mode and, as illustrated, the power tool 20 outputs maximum torque with no impacting. A locking device 45 (FIG. 9) is set between the torque ring 42 and the percussion ring 47. In a preferred embodiment, while not limiting, the lock device 45 is formed as a shoulder pin. When the power tool 20 is in the “no drilling” operating mode, one end of the locking device 45 is connected to the non-groove part of the torque ring 42 and the other end of the locking device 45 engages with a groove 49 of the percussion ring 47 and compresses a spring 46 which is set on the locking device 45 so that, when the power tool 20 is in the “no drilling” operating mode, the percussion ring 47 is locked and not operable to work. While the power tool 20 is in the “drilling” operating mode (FIG. 10), the end of the locking device 45 that is near the torque ring 42 engages with a groove 44 of the torque ring 42 and the other end of the locking device 45 is caused to disengage with the groove 49 of the percussion ring 47 by the spring 46 and, in this mode, the torque ring 42 is locked and the percussion ring 47 is operable to work. When the power tool 20 is in the “drilling” operating mode, the percussion ring 47 can be moved to its “percussion drilling” mode position to place the power tool 20 into the “percussion drilling” operating mode.

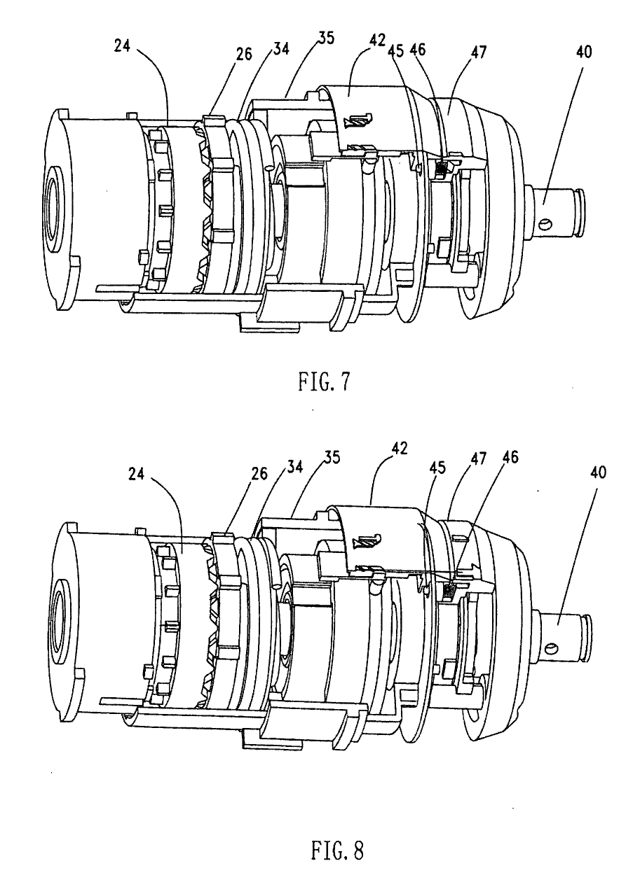

FIG. 8 is an assembly view of the power tool 20 in the “percussion drilling” operating mode and, as illustrated, when the percussion ring 47 is moved to the “percussion drilling” mode position the cam discs 25 and 27 are coupled to achieve the “percussion” operating mode. In this mode the power tool 20 outputs the maximum torque.

It will be understood that each of the elements described above, or two or more together, may also find a useful application in other types of constructions differing from the types described above.

While the invention has been illustrated and described as embodied in a hand power tool, in particular a drilling screwdriver, it is not intended to be limited to the details shown, since various modifications and structural changes may be made without departing in any way from the spirit of the present invention.

The subject disclosure fully reveals the present invention in a manner understood by those of skill in the art such that others can, by applying current knowledge, readily adapt it for various applications without omitting features that, from the standpoint of the prior art, fairly constitute essential characteristics of the generic or specific aspects of the invention.

What is claimed is:

1. A power tool, comprising: a motor, a clutch device for adjusting motor torque, a percussion device having two cam discs, and two adjusting rings for selectively setting four operating modes including a “screwdriving” operating mode, an “impacting” operating mode, a “drilling” operating mode and a “percussion drilling” operating mode, wherein one of the two adjusting rings is a torque adjusting ring operable to select one of the “screwdriving” operating mode, the “impacting” operating mode and the “drilling” operating mode while the other one of the two adjusting rings is a percussion ring operable to selectively set the “percussion drilling” operating mode.

2. The power tool according to claim 1, further comprising a locking device which is set between the two adjusting rings.

3. The power tool according to claim 2, wherein the locking device has two ends wherein one end is operable to be selectively connected to the torque adjusting ring and the other end is operable to be selectively connected to the percussion ring, wherein each of the two adjusting rings has a lock portion and wherein the torque adjusting ring is locked when the locking device engages with the lock portion of the torque adjusting ring and the percussion ring is locked when the locking device engages with the lock portion of the percussion ring.

4. The power tool according to claim 3, further comprising a spring set on the locking device.

5. The power tool according to claim 4, wherein the lock part of the torque ring is a groove formed thereon.

6. The power tool according to claim 4, wherein the lock part of the percussion ring is a groove formed thereon.

7. The power tool according to claim 2, wherein the lock device comprises a shoulder pin.

8. The power tool according to claim 3, wherein the lock device comprises a shoulder pin.

9. The power tool according to claim 4, wherein the lock device comprises a shoulder pin.

10. The power tool according to claim 5, wherein the lock device comprises a shoulder pin.

11. The power tool according to claim 6, wherein the lock device comprises a shoulder pin.

12. The power tool according to claim 1, wherein the torque adjusting ring is cooperable with the clutch device and the percussion ring is cooperable with the percussion device.
